(19) United States
(12) Patent Application Publication
(10) Pub. No.: US 2023/0244977 A1
(43) Pub. Date: Aug. 3, 2023

(54) QUANTUM DECOHERENCE DEGREE MEASUREMENT METHOD AND APPARATUS, ELECTRONIC DEVICE, AND STORAGE MEDIUM

(71) Applicant: INSPUR SUZHOU INTELLIGENT TECHNOLOGY CO., LTD., Jiangsu (CN)

(72) Inventors: Chen LI, Jiangsu (CN); Xin ZHANG, Jiangsu (CN); Jinzhe JIANG, Jiangsu (CN); Yaqian ZHAO, Jiangsu (CN); Rengang LI, Jiangsu (CN)

(21) Appl. No.: 18/044,277

(22) PCT Filed: Apr. 26, 2021
(86) PCT No.: PCT/CN2021/089966

§ 371 Date: Mar. 7, 2023

(30) Foreign Application Priority Data
Oct. 22, 2020 (CN) 202011141385.5

(51) Int. Cl. G06N 10/40

(52) U.S. Cl. CPC G06N 10/40

(57) ABSTRACT

Provided are a method and apparatus for measuring the quantum decoherence degree, an electronic device and a computer-readable storage medium. The method includes: determining an initial quantum state and a point to be measured of a quantum system to be measured (S101); amplifying the amplitude of the quantum state of the point to be measured, and measuring a decoherence degree of the point to be measured (S102); and calculating a decoherence coefficient of the quantum system to be measured according to the decoherence degree (S103). According to the method for measuring the quantum decoherence degree, the amplitude of the quantum state of the point to be measured in the quantum system to be measured is amplified, and the probability of the point to be measured is obtained by means of measurement, so as to measure the decoherence degree of the point to be measured. Meanwhile, the decoherence coefficient of the quantum system to be measured may be calculated quantitatively according to the measured decoherence degree. Therefore, an effective quantum system decoherence analysis system is provided.

### CROSS-REFERENCE TO RELATED APPLICATION

The present disclosure claims priority to Chinese Patent Application No. 202011141385.5, filed to the China National Intellectual Property Administration on Oct. 22, 2020 and entitled “Quantum Decoherence Degree Measurement Method and Apparatus, Electronic Device, and Storage Medium”, the disclosure of which is hereby incorporated by reference in its entirety.

### TECHNICAL FIELD

The present disclosure relates to the technical field of quantum computation, and more particularly, to a method for measuring the quantum decoherence degree and apparatus, and an electronic device and a computer-readable storage medium.

### BACKGROUND

Quantum computation is new computation that performs operations using quantum mechanical properties (such as superposition and entanglement). At present, it has been proved that quantum computation has much more computing power than classical computation in some fields. In a quantum computation system, information is stored in the form of quantum bits. Similar to classical bits, the quantum bits also have states, which may be either a ground state of |0 [symbol] or |1 [symbol] , or a linear combination of |0 [symbol] and |1 [symbol] , called a superposition state. The quantum states are susceptible to environmental influences, resulting in information distortion. The quantum bits in the superposition state are entangled with the surrounding physical environment over time, resulting in the loss of the information stored in the quantum bits, a phenomenon known as decoherence.

In widely used superconducting quantum computers and nuclear magnetic resonance quantum computers, the common quantum decoherence is caused by energy loss. For a single quantum bit, the state |0 [symbol] is the lowest energy state and also the most stable state. The energy of all systems in other states will be lost over time, gradually collapsing towards the state |0 [symbol] . A decoherence degree of the quantum bits increases exponentially with time. When decoherence occurs, the quantum information becomes classical information and loses its quantum advantage. Solving the decoherence problem has always been one of the difficult problems in quantum computation, and there are a lot of researches to extend the time of quantum decoherence. So far, no systematic method for measuring the quantum decoherence degree has been proposed.

Therefore, how to measure the quantum decoherence degree is a technical problem to be solved by those skilled in the art.

### SUMMARY

The object of the present disclosure is to provide a method and apparatus for measuring quantum decoherence degree, an electronic device and a computer-readable storage medium, which achieve the measurement of a quantum decoherence degree.

In order to achieve the above object, an embodiment of the present disclosure provides a method for measuring the quantum decoherence degree, which includes the following operations: An initial quantum state and a point to be measured of a quantum system to be measured are determined; the amplitude of the quantum state of the point to be measured is amplified, and a decoherence degree of the point to be measured is measured; a decoherence coefficient of the quantum system to be measured is calculated according to the decoherence degree.

The operation of measuring the decoherence degree of the point to be measured includes the following operation: a corresponding measurement method is determined according to the type of the quantum system to be measured, and the decoherence degree of the point to be measured is measured using the measurement method.

The operation of measuring the decoherence degree of the point to be measured using the measurement method includes the following operation: the decoherence degree of the point to be measured is measured multiple times using the measurement method, and an average value of all measurement results is taken as a final decoherence degree.

The operation of amplifying the amplitude of the quantum state of the point to be measured includes the following operations: a phase flip matrix corresponding to the point to be measured is determined. If the point to be measured is the k-th position point, the k-th diagonal element in the phase flip matrix is −1, other diagonal elements are 1, and an off-diagonal element is 0; the amplitude of the quantum state of the point to be measured is amplified multiple times using a Grover algorithm based on the phase flip matrix.

The method for measuring the quantum decoherence degree further includes the following operation:

the number of amplifying the amplitude of the point to be measured is calculated according to the initial quantum state. The calculation formula for the number of amplifying the amplitude is specifically:

$$R = [ \frac{π}{4} \sqrt{N} ] ;$$

where R is the number of amplifying the amplitude and N is the total number of position points in the initial quantum state.

The operation of calculating the decoherence coefficient of the quantum system to be measured according to the decoherence degree includes the following operations: a decoherence degree theoretical formula is determined by comparing an actual amplitude amplification degree of the quantum state of the point to be measured with an amplitude amplification degree when it is assumed that decoherence does not occur; the decoherence coefficient is calculated according to the measured decoherence degree and the decoherence degree theoretical formula.

The decoherence degree theoretical formula is specifically:

$$D c = {cos}^{2} ( \frac{π}{2} \sqrt{{e}^{- \frac{t}{T}}} ) ,$$

where Dc is the decoherence degree, t is time, T is the decoherence coefficient,

$${cos}^{2} ( \frac{π}{2} \sqrt{{e}^{- \frac{t}{T}}} )$$

is the actual amplitude amplification degree of the quantum state of the point to be measured, and the amplitude amplification degree is 1 when it is assumed that decoherence does not occur.

In order to achieve the above object, an embodiment of the present disclosure provides An apparatus for measuring a quantum decoherence degree, which includes a determination module, a measurement module and a calculation module.

The determination module is configured to determine an initial quantum state and a point to be measured of a quantum system to be measured.

The measurement module is configured to amplify the amplitude of the quantum state of the point to be measured, and measure a decoherence degree of the point to be measured.

The calculation module is configured to calculate a decoherence coefficient of the quantum system to be measured according to the decoherence degree.

In order to achieve the above object, an embodiment of the present disclosure provides an electronic device, which includes a memory and a processor.

The memory is configured to store a computer program.

The processor is configured to implement steps of the above method for measuring the quantum decoherence degree when executing the computer program.

In order to achieve the above object, the present disclosure provides a computer-readable storage medium, on which a computer program is stored. When executed by a processor, the computer program implements the steps of the above method for measuring the quantum decoherence degree.

From the above solutions, the method for measuring the quantum decoherence degree provided by the present disclosure includes that: the initial quantum state and the point to be measured of the quantum system to be measured are determined; the amplitude of the quantum state of the point to be measured is amplified, and the decoherence degree of the point to be measured is measured; and the decoherence coefficient of the quantum system to be measured is calculated according to the decoherence degree.

In the method for measuring the quantum decoherence degree provided by the present disclosure, the amplitude of the quantum state of the point to be measured in the quantum system to be measured is amplified, and the probability of the point to be measured is obtained by means of measurement, so as to measure the decoherence degree of the point to be measured. Meanwhile, the decoherence coefficient of the quantum system to be measured may be calculated quantitatively according to the measured decoherence degree. Therefore, the method for measuring the quantum decoherence degree provided by the present disclosure provides an effective quantum system decoherence analysis system. The present disclosure also discloses an apparatus for measuring a quantum decoherence degree, an electronic device and a computer-readable storage medium, which also achieve the above technical effects.

It is to be understood that the above general description and the following detailed description are only exemplary and not intended to limit the present disclosure.

### BRIEF DESCRIPTION OF THE DRAWINGS

In order to more clearly illustrate the embodiments of the present disclosure or the technical solutions in the related art, the drawings used in the description of the embodiments or the related art will be briefly described below. It is apparent that the drawings described below are only some embodiments of the present disclosure. Other drawings may further be obtained by those of ordinary skill in the art according to these drawings without creative efforts. The drawings are used to provide a further understanding of the present disclosure, constitute a part of the specification, and used to explain the present disclosure together with the following specific implementation mode, but not to limit the present disclosure. In the drawings:

FIG. 1 is a flowchart of a method for measuring the quantum decoherence degree according to an exemplary embodiment.

FIG. 2 is a schematic diagram of a Grover algorithm according to an exemplary embodiment.

FIG. 3 is a circuit diagram of a method for measuring the quantum decoherence degree according to an exemplary embodiment.

FIG. 4 is a structural diagram of an apparatus for measuring a quantum decoherence degree according to an exemplary embodiment.

FIG. 5 is a structural diagram of an electronic device according to an exemplary embodiment.

### DETAILED DESCRIPTION OF THE EMBODIMENTS

The technical solutions in the embodiments of the present disclosure will be clearly and completely described in conjunction with the drawings in the embodiments of the present disclosure. It is apparent that the described embodiments are only a part of the embodiments of the present disclosure, and not all of them. All other embodiments obtained by those of ordinary skill in the art based on the embodiments of the present disclosure without creative efforts are within the scope of protection of the present disclosure.

The embodiments of the present disclosure provide a method for measuring the quantum decoherence degree, which achieves the measurement of a quantum decoherence degree.

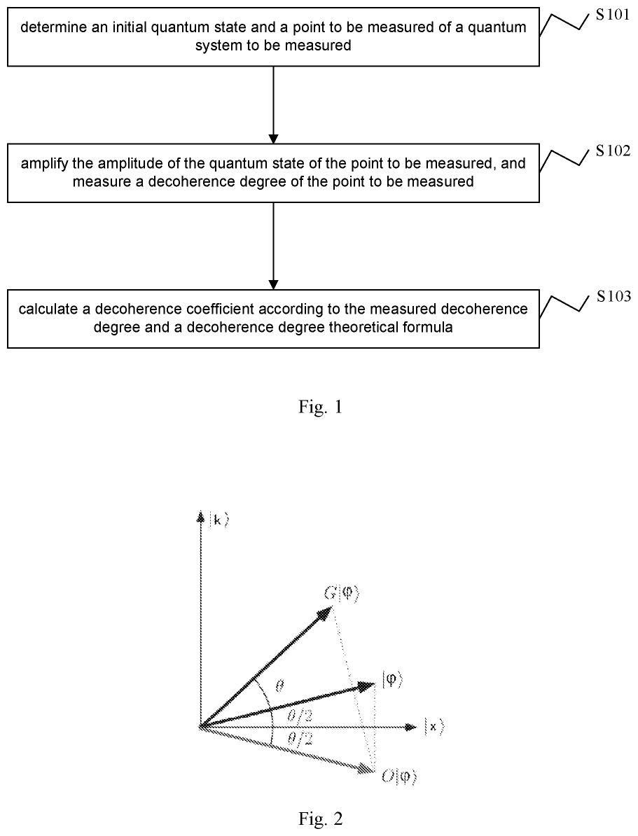

Referring to FIG. 1, a flowchart of a method for measuring the quantum decoherence degree according to an exemplary embodiment, as shown in FIG. 1, which includes the following operations.

At S101, an initial quantum state and a point (quantum bit) to be measured of a quantum system to be measured are determined.

A state of a single quantum bit may be expressed |φ [symbol] =α|0 [symbol] +β|1 [symbol] , where α and β are complex numbers, and |α|²+|β|²=1. Thus, the state of the single quantum bit may also be expressed as a vector (α, β)^{T} with a dimension of 2, and a length of the vector is 1. A measurement operation on a quantum system causes the system to collapse randomly to a ground state with a probability that depends on a coefficient before each ground state. When a plurality of quantum bits are entangled together, a corresponding number of ground states increases exponentially. The system with N entangled quantum bits has 2^{N} ground states, and a system state may be expressed as a linear superposition of the ground states.

In this step, firstly, the initial quantum state of the quantum system to be measured is determined. If the quantum state has been prepared and stored, the next step may be directly entered. If a new quantum state needs to be analyzed, this quantum state needs to be prepared. The initial quantum state of the quantum system to be measured is:

$$\vert {φ}_{0} 〉 = \frac{1}{\sqrt{N}} {\sum }_{x = 0}^{{2}^{N - 1}} \vert x 〉 ;$$

where x is a position point in the initial quantum state and N is the total number of the position points in the initial quantum state.

Secondly, a quantum position point k to be measured is determined among all the position points in the initialized quantum state, and the initial quantum state of the quantum position point k is |k [symbol] .

At S102, the amplitude of the quantum state of the point to be measured is amplified, and a decoherence degree of the point to be measured is measured.

In some embodiments, the amplitude of the quantum state after the flip of the point to be measured is amplified, and the probability of the point to be measured is measured, that is, the coefficient before |k> is amplified, and the probability of |k [symbol] obtained by theoretical measurement after multiple rounds of operations should be close to 100%.

As a feasible implementation mode, the operation of amplifying the amplitude of the quantum state of the point to be measured, and measuring the probability of the point to be measured includes: determining a phase flip matrix corresponding to the point to be measured, where if the point to be measured is the k^{th} position point, the k^{th} diagonal element in the phase flip matrix is −1, other diagonal elements are 1, and an off-diagonal element is 0; and amplifying the amplitude of the quantum state of the point to be measured multiple times using a Grover algorithm based on the phase flip matrix.

In some embodiments, the quantum state of the quantum system to be measured after performing phase flip on the point k to be measured is:

$$\vert {φ}_{1} 〉 = \frac{\sqrt{N - 1}}{\sqrt{N}} {\sum }_{x = 0 , x \neq k}^{{2}^{N - 1}} \vert x 〉 - \frac{1}{\sqrt{N}} \vert k 〉 .$$

A schematic diagram of the Grover algorithm is as shown in FIG. 2. In the figure, the initialized quantum state of the quantum system to be measured is |φ [symbol] , and then is ο|φ [symbol] after one flip, and then is G|φ [symbol] after two flips. Each Grover operation may flip the |x [symbol] towards |k [symbol] by a certain angle, and gradually approaches the |k [symbol] after multiple operations. The number of Grover operations, namely, the number of amplifying the amplitude, may be calculated according to the initial quantum state, namely, the present embodiment also includes: calculating the number of amplifying the amplitude of the point to be measured according to the initial quantum state.

$$if cos ( \frac{θ}{2} ) = \sqrt{( N - 1 ) / N} , and sin ( \frac{θ}{2} ) = \sqrt{1 / N} ,$$

after R times operations, then

$${G}^{R} \vert {φ}_{1} 〉 = cos ( \frac{2 R + 1}{2} θ ) {\sum }_{x = 0 , x \neq k}^{{2}^{N - 1}} \vert x 〉 + sin ( \frac{2 R + 1}{2} θ ) \vert k 〉 ,$$

and the number of operations R satisfies

$$\frac{2 R + 1}{2} θ = \frac{π}{2} ,$$

and when N is very large,

$$θ \approx sin θ = 2 sin ( \frac{θ}{2} ) cos ( \frac{θ}{2} ) = 2 \frac{\sqrt{N - 1}}{\sqrt{N}} \frac{1}{\sqrt{N}} \approx \frac{2}{\sqrt{N}} , and R = [ \frac{π}{4} \sqrt{N} ] .$$

It is to be understood that, for different quantum systems to be measured, the decoherence degree of the point to be measured may be measured using different measurement methods, namely, the operation of measuring the decoherence degree of the point to be measured includes: determining a corresponding measurement method according to the type of the quantum system to be measured, and measuring the decoherence degree of the point to be measured using the measurement method. A light quantum system is taken as an example, the corresponding measurement method thereof is to measure a polarization characteristic of the point to be measured, the polarization characteristic of the point to be measured k is lk, and the probability P that the polarization conforms to lk is obtained by means of measurement, that is, the probability |k [symbol] is obtained by measurement, and then the decoherence degree Dc=1−P.

In order to accurately measure the decoherence degree of the point to be measured, the decoherence degree of the point to be measured is measured many time, and an average value of all measurement results is taken as a final decoherence degree, that is, the operation of measuring the decoherence degree of the point to be measured using the measurement method includes: measuring the decoherence degree of the point to be measured multiple times using the measurement method, and taking the average value of all the measurement results as the final decoherence degree.

At S103, a decoherence coefficient is calculated according to the measured decoherence degree and a decoherence degree theoretical formula.

In some embodiments, the decoherence degree theoretical formula is determined by comparing an actual amplitude amplification degree of the quantum state of the point to be measured with an amplitude amplification degree when it is assumed that decoherence does not occur, and the decoherence coefficient is calculated according to the measured decoherence degree and the decoherence degree theoretical formula.

For a case where decoherence occurs, the quantum state of the system when decoherence occurs is:

$$\vert {φ}_{2} 〉 = ( \sqrt{1 - \frac{1}{N} {e}^{- \frac{t}{T}}} ) {\sum }_{x = 0 , x \neq k}^{{2}^{N - 1}} \vert x 〉 - ( \frac{1}{\sqrt{N}} \sqrt{{e}^{- \frac{t}{T}}} ) \vert k 〉 .$$

After the operation of the Grover algorithm, a final quantum state is:

$${G}^{{R}^{′}} \vert {φ}_{2} 〉 = cos ( \frac{2 {R}^{′} + 1}{2} {θ}^{′} ) {\sum }_{x = 0 , x \neq k}^{{2}^{N - 1}} \vert x 〉 - sin ( \frac{2 {R}^{′} + 1}{2} {θ}^{′} ) \vert k 〉 .$$

A case where N is very large is also considered,

$${θ}^{′} \approx sin {θ}^{′} = 2 \sqrt{1 - \frac{1}{N} {e}^{- \frac{t}{T}}} \frac{1}{\sqrt{N}} \sqrt{{e}^{- \frac{t}{T}}} \approx \frac{2}{\sqrt{N}} \sqrt{{e}^{- \frac{t}{T}}} .$$

If a case of being close to 90 degrees is satisfied after R′ iterations of the Grover algorithm, then

$${R}^{′} = [ \frac{π}{4} \sqrt{{Ne}^{t / T}} ] .$$

After decoherence occurs, still according to R operations, the probability of obtaining |k [symbol] when measuring the quantum state is not

$${sin}^{2} ( \frac{2 R + 1}{2} θ ) \approx {sin}^{2} \frac{π}{2} = 1 ,$$

but

$${sin}^{2} ( \frac{2 R + 1}{2} {θ}^{′} ) \approx {sin}^{2} ( \frac{π}{2} \sqrt{{e}^{- \frac{t}{T}}} ) .$$

The decoherence degree Dc is expressed as

$$Dc = 1 - {sin}^{2} ( \frac{π}{2} \sqrt{{e}^{- \frac{t}{T}}} ) = {cos}^{2} ( \frac{π}{2} \sqrt{{e}^{- \frac{t}{T}}} ) = Me ,$$

where Me is the probability of measuring a non-|k [symbol] state.

It may be seen that, when t is very long and the complete decoherence of the system occurs, the probability of measuring |k [symbol] is very small, while the probability Me of measuring the non-|k [symbol] state is close to 100%, that is, the decoherence degree is close to 100%. In the above formula, the decoherence degree Dc is obtained by means of measurement in S102, and deduction is made to obtain the decoherence coefficient T by calculation through the above formula.

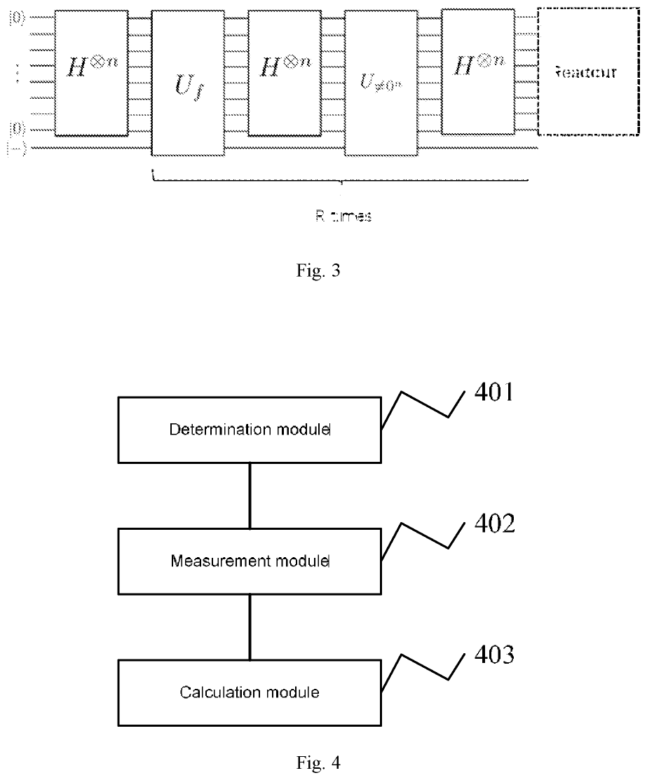

A circuit of the decorrelation degree measurement method is as shown in FIG. 3, the first H gate is the initialization of data, and if the existing quantum state is analyzed, the gate may be omitted, and a subsequent U_{f} gate flips a phase of a position point to be measured. U_{f}−H^{ϑn}−U_{≠0}_{ⁿ}−^{ϑn} four gates are then combined together into one Grover operation for a total of R operations, and finally Readout, namely measurement, is performed. Different quantum systems correspond to respective measurement methods.

It may be seen that, if this method is not used, the probability of directly measuring the point to be measured is

$$P 0 = ( 1 - Dc ) \times \frac{1}{N} ,$$

while the probability of measuring the point to be measured after using this method is P=1−Dc, and the efficiency is much higher than that of direct measurement. The time complexity

$$O ( {e}^{\frac{t}{T}} \sqrt{N} )$$

of measuring the decoherence is also less than the time complexity

$$O ( {e}^{\frac{t}{T}} \sqrt{N} )$$

of direct measurement. In this embodiment, the probability of monitoring the point to be measured is amplified using the Grover algorithm, and the decoherence degree is measured quantitatively.

In the method for measuring the quantum decoherence degree provided by the embodiment of the present disclosure, the amplitude of the quantum state of the point to be measured in the quantum system to be measured is amplified, and the probability of the point to be measured is obtained by means of measurement, so as to measure the decoherence degree of the point to be measured. Meanwhile, the decoherence coefficient of the quantum system to be measured may be calculated quantitatively according to the measured decoherence degree. Therefore, the method for measuring the quantum decoherence degree provided by the present disclosure provides an effective quantum system decoherence analysis system.

An apparatus for measuring a quantum decoherence degree provided by the embodiment of the present disclosure is described below, and the quantum decoherence degree measurement apparatus described below and the method for measuring the quantum decoherence degree described above may be referred to each other.

Referring to FIG. 4, a structural diagram of an apparatus for measuring a quantum decoherence degree shown according to an exemplary embodiment, as shown in FIG. 4, includes a determination module 401, a measurement module 402 and a calculation module 403.

The determination module 401 is configured to determine an initial quantum state and a point to be measured of a quantum system to be measured.

The measurement module 402 is configured to amplify the amplitude of the quantum state of the point to be measured, and measure a decoherence degree of the point to be measured.

The calculation module 403 is configured to calculate a decoherence coefficient of the quantum system to be measured according to the decoherence degree.

In the quantum decoherence degree measurement apparatus provided by the embodiment of the present disclosure, the amplitude of the quantum state of the point to be measured in the quantum system to be measured is amplified, and the probability of the point to be measured is obtained by means of measurement, so as to measure the decoherence degree of the point to be measured. Meanwhile, the decoherence coefficient of the quantum system to be measured may be calculated quantitatively according to the measured decoherence degree. Therefore, the quantum decoherence degree measurement apparatus provided by the embodiment of the present disclosure provides an effective quantum system decoherence analysis system.

On the basis of the above embodiment, as a preferred embodiment, the measurement module 402 includes an amplification unit and a measurement unit.

The amplification unit is configured to amplify the amplitude of the quantum state of the point to be measured.

The measurement unit is configured to determine a corresponding measurement method according to the type of the quantum system to be measured, and measure the decoherence degree of the point to be measured using the measurement method.

On the basis of the above embodiment, as a preferred embodiment, the measurement unit is specifically configured to determine the corresponding measurement method according to the type of the quantum system to be measured, measure the decoherence degree of the point to be measured multiple times using the measurement method, and take an average value of all measurement results as a final decoherence degree.

On the basis of the above embodiment, as a preferred embodiment, the amplification unit includes a determination sub-unit and an amplification sub-unit.

The determination sub-unit is configured to determine a phase flip matrix corresponding to the point to be measured. If the point to be measured is the k-th position point, the k-th diagonal element in the phase flip matrix is −1, other diagonal elements are 1, and an off-diagonal element is 0.

The amplification sub-unit is configured to amplify the amplitude of the quantum state of the point to be measured multiple times using a Grover algorithm based on the phase flip matrix.

On the basis of the above embodiment, as a preferred embodiment, the amplification unit further includes a calculation sub-unit.

The calculation sub-unit is configured to calculate the number of amplifying the amplitude of the point to be measured according to the initial quantum state. A calculation formula for the number of amplifying the amplitude is:

$$R = [ \frac{π}{4} \sqrt{N} ] .$$

Where R is the number of amplifying the amplitude and N is the total number of position points in the initial quantum state.

On the basis of the above embodiment, as a preferred embodiment, the calculation module 403 includes a determination unit and a calculation unit.

The determination unit is configured to determine a decoherence degree theoretical formula by comparing an actual amplitude amplification degree of the quantum state of the point to be measured with an amplitude amplification degree when it is assumed that decoherence does not occur.

The calculation unit is configured to calculate a decoherence coefficient according to the measured decoherence degree and the decoherence degree theoretical formula.

On the basis of the above embodiment, as a preferred embodiment, the decoherence degree theoretical formula is:

$$D c = {cos}^{2} ( \frac{π}{2} \sqrt{{e}^{- \frac{t}{T}}} ) ,$$

where Dc is the decoherence degree, t is time, T is the decoherence coefficient,

$${cos}^{2} ( \frac{π}{2} \sqrt{{e}^{- \frac{t}{T}}} )$$

is the actual amplitude amplification degree of the quantum state of the point to be measured, and the amplitude amplification degree is 1 when it is assumed that decoherence does not occur.

With respect to the device in the above embodiments, the specific mode in which the various modules perform operations has been described in detail in the embodiments of the method, which will not be described in detail herein.

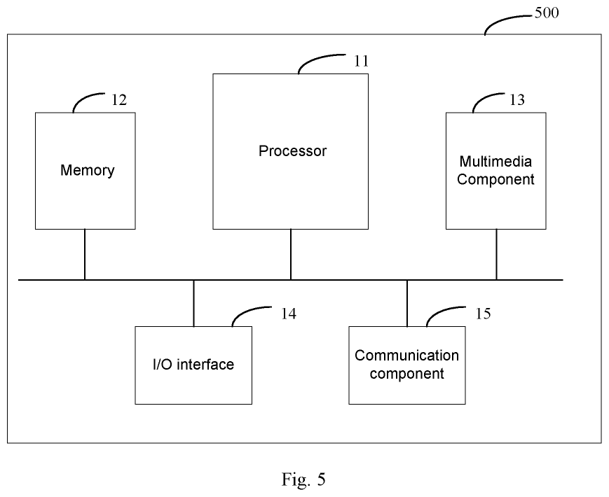

The present disclosure also provides an electronic device, referring to FIG. 5, a structural diagram of an electronic device 500 provided by an embodiment of the present disclosure, as shown in FIG. 5, may include a processor 11 and a memory 12. The electronic device 500 may also include one or more of a multimedia component 13, an Input/Output (I/O) interface 14, and a communication component 15.

Herein, the processor 11 is configured to control the overall operation of the electronic device 500 to complete all or part of the steps in the above method for measuring the quantum decoherence degree. The memory 12 is configured to store various type of data to support the operation of the electronic device 500. Such data may include, for example, instructions for any application programs or methods operated on the electronic device 500, as well as application-related data, such as contact data, sent and received messages, pictures, audio, video, etc. The memory 12 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk. The multimedia component 13 may include a screen and an audio component. The screen may be, for example, a touch screen, and the audio component is configured to output and/or input audio signals. For example, the audio component may include a microphone configured to receive external audio signals. The received audio signal may be further stored in the memory 12 or sent via the communication component 15. The audio component also includes at least one speaker configured to output the audio signals. The I/O interface 14 provides an interface between the processor 11 and other interface modules, which may be a keyboard, a mouse, buttons, and the like. These buttons may be virtual buttons or physical buttons. The communication component 15 is configured for wired or wireless communication between the electronic device 500 and other devices. Wireless communication may include, for example, one or a combination of Wi-Fi, Bluetooth, Near Field Communication (NFC), 2G, 3G or 4G, so that the communication component 15 may include: a Wi-Fi module, a Bluetooth module, and an NFC module correspondingly.

In an exemplary embodiment, the electronic device 500 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the above method for measuring the quantum decoherence degree.

In another exemplary embodiment, a computer-readable storage medium including a program instruction is also provided, and the program instruction is executed by a processor to implement the steps of the above method for measuring the quantum decoherence degree. For example, the computer-readable storage medium may be the above memory 12 including the program instruction executed by the processor 11 of the electronic device 500 to complete the above method for measuring the quantum decoherence degree.

The various embodiments in the description are described in a progressive manner, and each embodiment focuses on differences from other embodiments, and the same similar parts between the various embodiments may be referred to each other. For the apparatus disclosed in the embodiment, since it corresponds to the method disclosed in the embodiment, the description is relatively simple, and the relevant parts can be referred to the method part. It is to be noted that a number of variations and modifications may be made by those of ordinary skill in the art without departing from the principle of the present disclosure, and all fall within the scope of protection of the claims of the present disclosure.

It is also to be noted that relational terms “first”, “second” and the like in the specification are adopted only to distinguish one entity or operation from another entity or operation and not always to require or imply existence of any such practical relationship or sequence between the entities or operations. Furthermore, terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. Under the condition of no more limitations, an element defined by the statement “including a/an . . . ” does not exclude existence of the same other elements in a process, method, object or device including the element.

1. A method for measuring a quantum decoherence degree, comprising:
determining an initial quantum state and a point to be measured of a quantum system to be measured;
amplifying amplitude of the quantum state of the point to be measured, and measuring a decoherence degree of the point to be measured; and
calculating a decoherence coefficient of the quantum system to be measured according to the decoherence degree.

2. The method for measuring the quantum decoherence degree according to claim 1, wherein measuring the decoherence degree of the point to be measured comprises:
determining a corresponding measurement mode according to a type of the quantum system to be measured, and measuring the decoherence degree of the point to be measured using the measurement mode.

3. The method for measuring the quantum decoherence degree according to claim 2, wherein measuring the decoherence degree of the point to be measured using the measurement mode comprises:
measuring the decoherence degree of the point to be measured multiple times using the measurement mode, and determining an average value of all measurement results as a final decoherence degree.

4. The method for measuring the quantum decoherence degree according to claim 1, wherein amplifying the amplitude of the quantum state of the point to be measured comprises:
determining a phase flip matrix corresponding to the point to be measured, wherein, when the point to be measured is the k-th position point, the k-th diagonal element in the phase flip matrix is −1, other diagonal elements are 1, and an off-diagonal element is 0; and
amplifying, based on the phase flip matrix, the amplitude of the quantum state of the point to be measured multiple times using a Grover algorithm.

5. The method for measuring the quantum decoherence degree according to claim 4, further comprising:
calculating a number of amplifying the amplitude of the point to be measured according to the initial quantum state, wherein a calculation formula for the number of amplifying the amplitude is:
$$R = [ \frac{π}{4} \sqrt{N} ] ;$$
where R is the number of amplifying the amplitude and N is a total number of position points in the initial quantum state.

6. The method for measuring the quantum decoherence degree according to claim 5, wherein calculating the decoherence coefficient of the quantum system to be measured according to the decoherence degree comprises:
determining a decoherence degree theoretical formula by comparing an actual amplitude amplification degree of the quantum state of the point to be measured with an amplitude amplification degree when it is assumed that decoherence does not occur; and
calculating a decoherence coefficient according to the measured decoherence degree and the decoherence degree theoretical formula.

7. The method for measuring the quantum decoherence degree according to claim 6, wherein the decoherence degree theoretical formula is:
$$D c = {cos}^{2} ( \frac{π}{2} \sqrt{{e}^{- \frac{t}{T}}} ) ,$$
where Dc is the decoherence degree, t is time, T is the decoherence coefficient,
$${cos}^{2} ( \frac{π}{2} \sqrt{{e}^{- \frac{t}{T}}} )$$
is the actual amplitude amplification degree of the quantum state of the point to be measured, and the amplitude amplification degree is 1 when it is assumed that decoherence does not occur.

8. (canceled)

9. An electronic apparatus, comprising:
a memory, configured to store a computer program; and
a processor, configured to execute the computer program to:
determine an initial quantum state and a point to be measured of a quantum system to be measured;
amplify amplitude of the quantum state of the point to be measured, and measure a decoherence degree of the point to be measured; and
calculate a decoherence coefficient of the quantum system to be measured according to the decoherence degree.

10. A computer-readable storage medium, on which a computer program is stored, the computer program is configured to, when executed by a processor, cause the processor to:
determine an initial quantum state and a point to be measured of a quantum system to be measured;
amplify amplitude of the quantum state of the point to be measured, and measure a decoherence degree of the point to be measured; and
calculate a decoherence coefficient of the quantum system to be measured according to the decoherence degree.

11. The electronic apparatus according to claim 9, the processor is further configured to execute the computer program to:
determine a corresponding measurement mode according to a type of the quantum system to be measured, and measure the decoherence degree of the point to be measured using the measurement mode.

12. The electronic apparatus according to claim 11, the processor is further configured to execute the computer program to:
measure the decoherence degree of the point to be measured multiple times using the measurement mode, and determine an average value of all measurement results as a final decoherence degree.

13. The electronic apparatus according to claim 9, the processor is further configured to execute the computer program to:
determine a phase flip matrix corresponding to the point to be measured, wherein, when the point to be measured is the k-th position point, the k-th diagonal element in the phase flip matrix is −1, other diagonal elements are 1, and an off-diagonal element is 0; and
amplify, based on the phase flip matrix, the amplitude of the quantum state of the point to be measured multiple times using a Grover algorithm.

14. The electronic apparatus according to claim 13, the processor is further configured to execute the computer program to:
calculate a number of amplifying the amplitude of the point to be measured according to the initial quantum state, wherein a calculation formula for the number of amplifying the amplitude is:
$$R = [ \frac{π}{4} \sqrt{N} ] ;$$
where R is the number of amplifying the amplitude and N is a total number of position points in the initial quantum state.

15. The electronic apparatus according to claim 14, the processor is further configured to execute the computer program to:
determine a decoherence degree theoretical formula by comparing an actual amplitude amplification degree of the quantum state of the point to be measured with an amplitude amplification degree when it is assumed that decoherence does not occur; and
calculate a decoherence coefficient according to the measured decoherence degree and the decoherence degree theoretical formula.

16. The electronic apparatus according to claim 15, wherein the decoherence degree theoretical formula is:
$$D c = {cos}^{2} ( \frac{π}{2} \sqrt{{e}^{- \frac{t}{T}}} ) ,$$
where Dc is the decoherence degree, t is time, T is the decoherence coefficient,
$${cos}^{2} ( \frac{π}{2} \sqrt{{e}^{- \frac{t}{T}}} )$$
is the actual amplitude amplification degree of the quantum state of the point to be measured, and the amplitude amplification degree is 1 when it is assumed that decoherence does not occur.

17. The computer-readable storage medium according to claim 10, the computer program is further configured to, when executed by the processor, cause the processor to:
determine a corresponding measurement mode according to a type of the quantum system to be measured, and measure the decoherence degree of the point to be measured using the measurement mode.

18. The computer-readable storage medium according to claim 17, the computer program is further configured to, when executed by the processor, cause the processor to:
measure the decoherence degree of the point to be measured multiple times using the measurement mode, and determine an average value of all measurement results as a final decoherence degree.

19. The computer-readable storage medium according to claim 10, the computer program is further configured to, when executed by the processor, cause the processor to:
determine a phase flip matrix corresponding to the point to be measured, wherein, when the point to be measured is the k-th position point, the k-th diagonal element in the phase flip matrix is −1, other diagonal elements are 1, and an off-diagonal element is 0; and
amplify, based on the phase flip matrix, the amplitude of the quantum state of the point to be measured multiple times using a Grover algorithm.

20. The computer-readable storage medium according to claim 19, the computer program is further configured to, when executed by the processor, cause the processor to:
calculate a number of amplifying the amplitude of the point to be measured according to the initial quantum state, wherein a calculation formula for the number of amplifying the amplitude is:
$$R = [ \frac{π}{4} \sqrt{N} ] ;$$
where R is the number of amplifying the amplitude and N is a total number of position points in the initial quantum state.

21. The electronic apparatus according to claim 20, the computer program is further configured to, when executed by the processor, cause the processor to:
determine a decoherence degree theoretical formula by comparing an actual amplitude amplification degree of the quantum state of the point to be measured with an amplitude amplification degree when it is assumed that decoherence does not occur; and
calculate a decoherence coefficient according to the measured decoherence degree and the decoherence degree theoretical formula.
